(19) United States
(12) Patent Application Publication
(10) Pub. No.: US 2025/0319474 A1
(43) Pub. Date: Oct. 16, 2025

(54) METHOD FOR OPERATING A MATERIAL CRUSHING PLANT

(71) Applicant: Hazemag & EPR GmbH, Dülmen (DE)

(72) Inventor: Hendrik Wirth, Dülmen (DE)

(73) Assignee: Hazemag & EPR GmbH, Dülmen (DE)

(21) Appl. No.: 19/051,787

(22) Filed: Feb. 12, 2025

(30) Foreign Application Priority Data
Feb. 27, 2024 (EP) 24159891.1

(51) Int. Cl. B02C 25/00; B02C 23/00

(52) U.S. Cl. CPC B02C 25/00; B02C 23/00

(57) ABSTRACT

The disclosure relates to a method for operating a material crushing plant having at least one crushing unit to which material to be crushed is continuously fed and at least one conveyor belt by means of which the material crushed by the at least one crushing unit is transported away. The method involves taking an image of the crushed material on the conveyor belt using an optical analysis system. The image taken is then analyzed, wherein geometric properties of the crushed material are determined during the analysis process and a current material distribution of different material sizes in the crushed material is calculated on the basis of the determined geometric properties using the optical analysis system. A difference between the calculated and current material distribution and a target material distribution specified by an operator is then calculated using the optical analysis system, wherein at least one operating parameter of the crushing unit is then adjusted autonomously while the material crushing plant is operating by means of the optical analysis system if the calculated difference lies outside a specified tolerance range for a specified period of time.

### BACKGROUND OF THE DISCLOSURE

The disclosure relates to a method for operating a material crushing plant, wherein the material crushing plant has at least one crushing unit to which material to be crushed is continuously fed, and at least one conveyor belt by means of which the material crushed by the at least one crushing unit is transported away.

Modern material crushing plants are often equipped with advanced open-loop control systems that allow precise open-loop control of the crushing process in terms of adjusting the crushing intensity and monitoring the material feed. Such open-loop control systems collect data from various sensors of the material crushing plant and make it easier for an operator to monitor the material crushing plant and possibly adapt operating parameters of the material crushing plant if the system reports deviations from desired target values to the operator.

### SUMMARY OF THE DISCLOSURE

The object of the disclosure is to create a solution that optimizes the crushing process of a material crushing plant in a structurally simple manner.

This object is achieved according to the disclosure by a method having the features according to claim 1.

The method according to the disclosure for operating a material crushing plant, which comprises at least one crushing unit to which material to be crushed is continuously fed and at least one conveyor belt by means of which the material crushed by the at least one crushing unit is transported away, comprises the following steps:
taking an image of the crushed material on the conveyor belt using an optical analysis system,
analyzing the image taken, wherein geometric properties of the crushed material are determined during the analysis process and a current material distribution of different material sizes in the crushed material is calculated on the basis of the determined geometric properties using the optical analysis system,
calculating a difference between the calculated and current material distribution and a target material distribution specified by an operator using the optical analysis system, and
autonomously adjusting at least one operating parameter of the crushing unit while the material crushing plant is operating by means of the optical analysis system if the calculated difference lies outside a specified tolerance range for a specified period of time. The adjustment is carried out step by step autonomously and involves readjusting at least one operating parameter of the crushing unit while the material crushing plant is in operation, with the help of the optical analysis system, in order to independently achieve the target material distribution again.

Advantageous and expedient embodiments and developments of the disclosure are disclosed in the corresponding dependent claims.

### DETAILED DESCRIPTION OF THE DISCLOSURE

The disclosure provides a method for operating a material crushing plant, wherein the method is characterized by optimization of the crushing processes through precise analysis and adaptation of operating parameters in order to ensure consistent product quality. In the method according to the disclosure, among other things, geometric properties of the crushed material and resulting mathematical dependencies are analyzed and compared. If the analyzed values of the crushed material differ from target specifications beyond a specified geometric difference and beyond a specified period of time, the method according to the disclosure can independently autonomously readjust the operating parameters of the crushing unit in steps in order to independently achieve the target specifications again. These operating parameters are adapted during operation of the crushing plant. According to the disclosure, intervention by an operator of the material crushing plant is therefore no longer necessary. The adjustment and readjustment of at least one operating parameter of the crushing unit during operation of the material crushing plant with the help of the optical analysis system takes place step by step, iteratively and autonomously. The optical analysis system recognizes trends and patterns in the crushed material and, based on this, iteratively optimizes the adjustment of the crushing unit in order to independently and without operator intervention achieve the target material distribution specified by the operator. An essential feature of the disclosure is the integration of an optical analysis system that is responsible for monitoring and controlling the crushing process using open-loop control. This optical analysis system is capable of taking images of the crushed material on the conveyor belt and analyzing these images in detail. The analysis involves determining geometric properties of the crushed material and calculating the current material distribution on the basis on these properties. This information is used to calculate a difference between the current material distribution and a target material distribution specified by the operator. According to the disclosure, the optical analysis system monitors the current material distribution, whereas the operator only specifies the target material distribution to be achieved.

With regard to the autonomous adjustment of at least one operating parameter of the material crushing plant, it is advantageous in one embodiment of the disclosure if, during the analysis process, the image taken is entered into a neural network and the geometric properties of the crushed material are determined using the neural network. In this case, the optical analysis system for analyzing the neural network has or the optical analysis system is coupled to the neural network for analyzing. The neural network is able to recognize trends and patterns in the crushed material and/or can make predictions about the condition/state of the material crushing plant and, based on this, make automated process optimization decisions. The neural network is consequently integrated into the iterative adjustments of the crushing unit in the event of deviations in the current material distribution that fall outside the tolerance range. This neural network can be trained with similar or identical material data records before the plant is started up and/or updated with reference data records during operation or in test phases. This makes it possible, for example, to identify trends and patterns in the crushing process and, based on this, to adjust at least one operating parameter of the crushing unit. This technology significantly improves the accuracy of material analysis. There are prepared programming tools and corresponding software for neural networks that map essential processing steps of the neural network. This software is pre-made in such a way that a neural network can be adapted, parameterized and trained with little programming effort. The method according to the disclosure for operating a material crushing plant uses static software that does not carry out or permit any changes during runtime because the aspects of predictability, reliability and security are important and unexpected changes could lead to errors or security gaps.

According to one embodiment of the method according to the disclosure, it is provided that a convolutional neural network (CNN) is used as the neural network. The convolutional neural network (CNN) is a special group of computer-based neural networks that are particularly effective at processing data with a known topology, such as images that can be viewed as a 2D grid of pixels. The architecture of a CNN is specifically designed to exploit the strong spatial correlations in visual data. A CNN typically consists of a sequence of layers (convolutional layers, pooling layers, fully connected layers, activation functions) that perform different types of operations. Through training, filters in the convolutional layers learn to extract useful visual features without explicit programming, and the fully connected layers learn to use these features to perform specific tasks, such as classification.

In a further embodiment of the method according to the disclosure, it is advantageous if, before the material crushing plant is started up, the neural network is trained using data records consisting of analyzed images of a material that is similar or identical to the material to be crushed. These data records correspond to training data records that, in addition to the optical image analysis, contain further operating data for the material crushing plant that were recorded for a long and trouble-free operating period for a specific type of material such that these training data are used by the neural network to recognize whether, for example, a material that differs from the desired material is fed to the crushing unit and/or the degree of wear of the crushing unit, wherein the neural network is then able to adapt the crushing unit autonomously and without operator intervention on the basis of the different material and to ensure the desired crushing and/or to readjust gap widths of the crushing unit autonomously and without operator intervention in accordance with the wear detected. Accordingly, the optical analysis system is designed on the basis of the determined geometric properties of the crushed material in such a way that the neural network autonomously adjusts the crushing unit in accordance with a deviating material and without the intervention of an operator, and ensures a desired crushing, and/or that the neural network adjusts the gap widths of the crushing unit in accordance with an established degree of wear, autonomously and without the intervention of an operator.

In a further embodiment, the disclosure provides that during operation or during a test run of the material crushing plant, the neural network is supplied with a reference data record, wherein an operator takes a sample of the crushed material from the conveyor belt for the reference data record and the sample is analyzed by the operator.

In an embodiment of the method according to the disclosure, it is further provided that during the analysis process, regions of crushed material are identified in the image taken and an associated cubic shape/cubicity is determined for each identified region of crushed material in the image taken.

In order to ensure a high reaction speed and timeliness of the open-loop process control, a further embodiment of the method of the disclosure provides that at least five images are taken and analyzed per minute.

In order to avoid a falsification of the result of the analysis due to separation of the crushed material, a further embodiment of the disclosure provides that a correction factor for the conveying path of the crushed material, which conveying path extends from the crushing unit to the position of the image via the conveyor belt, is taken into account when calculating the current material distribution.

With regard to achieving consistent product quality, the disclosure further provides that, during the autonomous adjustment process during operation, a gap width and/or a rotor speed of the crushing unit is adjusted in steps using closed-loop control until the calculated difference lies within the specified tolerance range.

Finally, in a further embodiment of the method, it is provided that the results of the analysis by the optical analysis system are sent to a machine console of the material crushing plant and/or to a decentralized database system and/or to a decentralized visualization system. The optical analysis system can therefore summarize and present the results of the analysis in such a way that quantifiable statements can be made about the quality and geometric and volumetric properties of the crushed material. The results and statements can be decentrally stored, retrieved and displayed as information in a database or visualization system.

It goes without saying that the features mentioned above can be used not only in each of the specified combinations, but also in other combinations or in isolation, without departing from the scope of the present disclosure. The scope of the disclosure is defined only by the claims. Further details, features, and advantages of the subject matter of the disclosure can be found in the following description.

The disclosure is directed at a method for operating a material crushing plant by means of an optical analysis system. The material crushing plant comprises at least one crushing unit to which material to be crushed is continuously fed and at least one conveyor belt by means of which the material crushed by the at least one crushing unit is transported away. By means of the method, according to the disclosure at least one operating parameter of the at least one crushing unit can be controlled autonomously using closed-loop control. The at least one crushing unit can be, for example, an impact crusher, a hammer crusher, a cone crusher, a jaw crusher, a roller crusher, a sizer or any other crusher for crushing material, such as mineral raw materials.

In the method according to the disclosure, the broken or crushed material emerging from the crushing unit is picked up, processed and analyzed by means of an optical analysis system in order to compare this analysis result with target values that can be entered into the system by an operator of the material crushing plant. Accordingly, in the method according to the disclosure, an image of the crushed material on the conveyor belt is taken by the optical analysis system in one method step. The optical analysis system has a camera device that takes the image. The image is an image taken from above the conveyor belt on which the crushed material is transported. In a further step, the image taken is then analyzed by the optical analysis system. For the analysis, the optical analysis system comprises a neural network of the optical analysis system is coupled to a neural network. Thus, the analysis is carried out with the help of an artificial intelligence or the analysis is supported by an artificial intelligence (AI-supported analysis). During the analysis process, geometric properties of crushed material are determined, among other things. The optical analysis system determines and identifies the outlines in the image as regions of crushed material. Based on the outlines, a square is then determined for each outline identified, which square forms the outline so that the respective lengths and widths for the crushed material can be determined by the optical analysis system using the square. In this way, the optical analysis system determines an associated cubic shape/cubicity for each identified region of crushed material in the image taken. Detailed analysis by identifying specific regions and determining a cubic shape/cubicity allows even more precise open-loop control of the crushing process.

Furthermore, the optical analysis system uses the determined geometric properties, which were determined from the image taken for the crushed material, to calculate a current material distribution of different material sizes in the crushed material. The material distribution describes the range of particle sizes present in the crushed material from the smallest to the largest particles and is called the grain size range. For continuous and up-to-date information regarding the material distribution or grain size range, at least five images are taken and analyzed per minute.

The determination and identification of the geometric properties from the image taken is done through AI-supported analysis. For example, when analyzing, the image taken can be entered into the neural network. The neural network is then used to determine the geometric properties of the crushed material. For this purpose, for example, a convolutional neural network (CNN) can be used as the neural network. Regardless of which type of neural network is used, before the material crushing plant is started up, the neural network can be trained using data records consisting of analyzed images of a material that is similar or identical to the material to be crushed. It is also conceivable that during operation or during a test run of the material crushing plant, the neural network is supplied with a reference data record, wherein an operator takes a sample of the crushed material from the conveyor belt for the reference data record and the sample is analyzed by the operator.

The method step of analyzing the image taken is followed by the method step of calculating a difference between the calculated and current material distribution and a target material distribution specified by an operator by means of the optical analysis system. In this method step, the calculated and current material distribution, i.e. the grain size range, is thus compared to a target material distribution specified by an operator of the material crushing plant.

When calculating the difference or when comparing the current material distribution and the specified target material distribution, a correction factor for the conveying path of the crushed material, which conveying path extends from the crushing unit to the position of the image, can be taken into account when calculating the current material distribution. This correction factor takes into account any separation of the crushed material along the conveying path on the conveyor belt in which the particles of the crushed material are sorted or separated according to size, shape or density instead of forming a uniform mixture. Accordingly, when calculating the current material distribution, a correction factor is taken into account for a conveying path of the crushed material, which (the conveying path) extends from the comminution unit to the position of the image recording, the correction factor taking into account a segregation of the crushed material along the conveying path on the conveyor belt, in which the particles of the crushed material sort and/or segregate according to size, shape and/or density and/or segregation of the particles of the crushed material according to size, shape and/or density.

If the material distribution of the currently crushed material that results and is calculated from the analysis differs from the target material distribution for a specified period of time and by a specified tolerance range, the next method step involves autonomously adjusting at least one operating parameter of the crushing unit during operation of the material crushing plant by means of the optical analysis system. With the help of the optical method and the AI-supported analysis, the method according to the disclosure is independently capable of autonomously adjusting and readjusting the operating parameters of the crushing unit, such as gap widths and/or speeds, rotor speed, in steps in order to independently achieve the target specifications in the form of the target material distribution. Consequently, the method according to the invention comprises the step of a stepwise autonomous adjustment and readjustment of at least one operating parameter of the crushing unit during operation of the material crushing plant with the aid of the optical analysis system, when the calculated deviation is outside a predetermined tolerance range for a predetermined period of time, in order to independently achieve the predetermined target material distribution again. The adaptation of these operating parameters takes place during production operation of the material crushing plant if the calculated difference is outside a specified tolerance range for a specified period of time.

The results of the analysis by the optical analysis system can be sent to a machine console of the material crushing plant and/or to a decentralized database system and/or to a decentralized visualization system. This makes it possible to summarize and present the measured, determined and calculated results in such a way that quantifiable statements can be made about the quality and geometric and volumetric properties of the crushed product. This information can be stored, retrieved and displayed in the database and visualization system of the disclosure and also in other database or visualization systems. Furthermore, the results of the analysis by the optical analysis system allow conclusions to be drawn about the state of wear of the crushing unit and whether another material is being or has been fed to the crushing unit in the meantime in order to be crushed. Based on the conclusions, the optical analysis system can then change so-called recipes (predetermined gap widths of the crushing unit for a specific material to be crushed) and/or change the rotor speed without operator intervention in order to autonomously adapt either to the state of wear of the crushing unit and/or to a different material.

In summary, the disclosure allows efficient and precise open-loop control of material crushing plants through an optical analysis system that performs an AI-supported analysis of the crushed material. The method according to the disclosure has the ability to autonomously adapt operating parameters of the crushing unit if the detected difference lies outside a defined tolerance range for a certain period of time. This allows continuous optimization of the crushing process and ensures consistently high product quality. The operator of the material crushing plant only has to specify the target product without having to make manual adjustments to the material crushing plant. The disclosure therefore significantly increases the accuracy, efficiency and flexibility of the operation of material crushing plants through the use of the most advanced technologies.

Of course, the disclosure described above is not limited to the embodiment described. It is evident that numerous modifications can be made that are obvious to those skilled in the art in accordance with the intended application, without leaving the scope of the disclosure. The disclosure includes everything contained in the description.

1. A method for operating a material crushing plant, wherein the material crushing plant has at least one crushing unit to which material to be crushed is continuously fed, and at least one conveyor belt by means of which the material crushed by the at least one crushing unit is transported away, wherein the method comprises the steps of:
taking an image of the crushed material on the conveyor belt using an optical analysis system,
analyzing the image taken, wherein geometric properties of the crushed material are determined during the analysis process and a current material distribution of different material sizes in the crushed material is calculated on the basis of the determined geometric properties using the optical analysis system,
calculating a difference between the calculated and current material distribution and a target material distribution specified by an operator using the optical analysis system, and
autonomously adjusting at least one operating parameter of the crushing unit while the material crushing plant is operating by means of the optical analysis system if the calculated difference lies outside a specified tolerance range for a specified period of time.

2. The method according to claim 1, wherein the image taken is entered into a neural network during the analysis process and the geometric properties of the crushed material are determined using the neural network.

3. The method according to claim 2, wherein a convolutional neural network (CNN) is used as the neural network.

4. The method according to claim 2, wherein, before the material crushing plant is started up, the neural network is trained using data records consisting of analyzed images of a material that is similar or identical to the material to be crushed.

5. The method according to claim 2, wherein, during operation or during a test run of the material crushing plant, the neural network is supplied with a reference data record, wherein a sample of the crushed material is taken from the conveyor belt by an operator for the reference data record and the sample is analyzed by the operator.

6. The method according to claim 2, wherein, during the analysis process, regions of crushed material are identified in the image taken and an associated cubic shape is determined for each identified region of crushed material in the image taken.

7. The method according to claim 1, wherein at least five images are taken and analyzed per minute.

8. The method according to claim 1, wherein a correction factor for the conveying path of the crushed material, which conveying path extends from the crushing unit to the position of the image, is taken into account when calculating the current material distribution.

9. The method according to claim 1, wherein, during the autonomous adjustment process during operation, a gap width and/or a rotor speed of the crushing unit is adjusted in steps using closed-loop control until the calculated difference lies within the specified tolerance range.

10. The method according to claim 1, wherein the results of the analysis by the optical analysis system are sent to a machine console of the material crushing plant and/or to a decentralized database system and/or to a decentralized visualization system.
